(19) United States
(12) Patent Application Publication
(10) Pub. No.: US 2024/0195916 A1
(43) Pub. Date: Jun. 13, 2024

(54) MICROPHONE MUTE NOTIFICATION WITH VOICE ACTIVITY DETECTION

(71) Applicant: RTX A/S, Nørresundby (DK)

(72) Inventors: Sebastian Biegel SCHIØLER, Aalborg (DK); Christian BRANDT, Aalborg (DK)

(21) Appl. No.: 18/555,018

(22) PCT Filed: Mar. 24, 2022
(86) PCT No.: PCT/EP2022/057830

§ 371 Date: Oct. 12, 2023

(30) Foreign Application Priority Data
Apr. 15, 2021 (EP) 21168551.6

(51) Int. Cl. H04M 3/56; G10L 21/0216; G10L 21/0232; G10L 21/034; G10L 21/0364; G10L 25/84; H04R 1/10; H04R 3/00

(52) U.S. Cl. CPC H04M 3/568; G10L 21/0232; G10L 21/034; G10L 21/0364; G10L 25/84; H04R 1/1041; H04R 3/005; G10L 2021/02165; G10L 2021/02166; H04R 2201/107; H04R 2410/05; H04R 2420/07

(57) ABSTRACT

A method and device, e.g. a headset, for notifying a user of a mute state of a primary microphone during a call, in case the user speaks while the primary microphone is muted. The method comprises performing a noise cancellation algorithm (ENC) on output signals from the primary microphone and on output signals from an additional microphone capturing sound in the user's surroundings to suppress surrounding noise at the user location. Further processing output signals from the primary microphone according to a Voice Activity Detection (VAD) algorithm by means of a processor system while the primary microphone is muted. The VAD algorithm is used to determine if speech is present, and next it is determined if an additional condition if fulfilled. Then, finally providing a mute state notification to the user only if it is determined that speech is present and the additional condition is fulfilled.

### FIELD OF THE INVENTION

The present invention relates to the field of audio communication, such as two-way audio communication over a communication link, e.g. on-line two-way communication. Specifically, the invention proposes a method for microphone mute notification to the user based on a voice activity detection algorithm, e.g. using one or more microphone inputs to eliminate or reduce disturbing notifications of the user.

### BACKGROUND OF THE INVENTION

A headset has many advantages for attending online calls or meetings, but some advantages also have drawbacks. It is desired to be able to mute the headset microphone if e.g., the user has nothing to add to the call for a while. One drawback with this functionality is that once the user wants to speak in the call, the user might have forgot that the microphone is muted.

This problem is in several cases solved by detecting if the user is speaking into a muted microphone and then making a visual or an audible notification to the user. The audible notification can be an advantage as the user in a call will always hear the notification. However, one drawback of this functionality is that sometimes the user might intentionally speak into a muted microphone.

For example, if the user is in a call, and at some point the user wants to speak to a colleague physically present near the user. The user's microphone is muted, so when the user starts the conversation with the colleague, an audible notification will played and thus disturb the user rather than serving as an assistance.

Further, another drawback is that the headset microphone also picks up surrounding sounds. These surroundings sounds may include a colleague speaking. This can lead to the situation where the user is in a call with the microphone muted, and when a colleague is speaking, the headset microphone picks up the speech and alerts the user that he is speaking into a muted microphone, which is not the case.

EP 2 881 946 A1 describes a microphone mute/unmute system which detects silence events and voice activities from far-end and near-end audio signals to determine whether an audio event is an interference event or a speaker event. The system described may further detect faces or motion from images from a camera to determine a mute or unmute indication.

US 2015/0195411 A1 describes a system for providing intelligent and automatic mute notification. The system provides mechanics for controlling false positive determinations of speaking through mute by utilizing a combination of recorded characteristics and initiated timers.

### SUMMARY OF THE INVENTION

Thus, according to the above description, it is an object of the present invention to provide method and an apparatus eliminating or reducing the problems with unintended notifications or alerts in case of a user participating in a call or conversation with a muted microphone.

In a first aspect, the invention provides a method for notifying a user of a mute state of a microphone system during a call with one or more other participants, in case the user speaks while the primary microphone of the microphone system is muted, the method comprising
processing an output signal from the microphone system, at least the primary microphone, according to a Voice Activity Detection (VAD) algorithm by means of a processor system while the primary microphone of the microphone system is muted,
determining if speech is present in accordance with an output of the Voice Activity Detection algorithm,
determining if an additional condition is fulfilled, and
providing a mute state notification to the user only if it is determined that speech is present and the additional condition is fulfilled.

Preferably, the microphone system comprises a primary microphone arranged to capture the user's speech and an additional microphone located to capture sound from the user's surroundings, and wherein the method comprises performing a noise cancellation algorithm by processing output signals from the primary microphone and output signals from the additional microphone to suppress surrounding noise. The additional microphone is preferably not connected to transmit audio to the call at any time, since its role is to provide information to determine whether to mute the primary microphone or not or to determine whether or not to send mute notifications.

Such method is advantageous, since a number of problems with simple notifications of a muted microphone can be eliminated or at least reduced. Thus, significant disturbance in various situations during a call can be avoided. Especially, the method is suitable for a headset arranged for connection to a computer, a tablet or smartphone or the like. In general the method can be used in various devices with a microphone intended for use in a call, and where the microphone has a mute function. Some parts of the method may advantageously be implemented on a processor in a headset or other device with a microphone and a loudspeaker, while other parts of the method may be implemented in components involved in facilitating the call, e.g. a computer or at a server providing an online call. Especially, a headset or other device may simply eliminate unintentional mute state notifications from the online call by muting the primary microphone.

The invention is based on the insight that a significant number of unintended microphone mute notifications can be eliminated or reduced in an intelligent way by rather simple processing which can be implemented e.g. in a headset. By use of a Voice Activity Detection (VAD) algorithm, it can be ensured that only speech in the muted microphone will trigger a mute state notification. Introducing further an additional condition to be fulfilled before a mute state notification is provided to the user, an intelligent detection of the user's activity can be provided, so as to significantly reduce disturbing mute state notifications, e.g. if the user speaks to a colleague in the physical surroundings. If the VAD algorithm finds that the user is speaking into the microphone, then an interrupt will be sent from the VAD algorithm, which will make the headset play e.g. a voice prompt saying, “Headset muted”. The mute state notification may be audible as the headset user will be most likely to observe this form of notification. Preferably, a frequency of the mute state notification should be configurable, e.g. configurable by the user, to avoid notifications being played too often if the headset user has a physical conversation.

Especially, use of more microphones apart from the primary user microphone can be used to detect another person speaking in the surroundings. Even further, a separate VAD algorithm can be used for detection of speech captured by such additional microphones. Still further, a separate VAD algorithm can be applied to an incoming audio signal in the call, thus allowing detection of other participants speaking, and e.g. only allow mute state notification to the user in case none of the other participants in the call are speaking, thereby indicating that it may be the intention of the user to speak.

Noise Cancellation (ENC or ANC) with one or more additional microphones assists the VAD algorithm and improving the VAD algorithm in making the decision of the presence of speech. The additional microphones can be used for performing beamforming to determine if the user is facing a speech source in the user's surroundings. If the user is facing a surrounding speech source, then the user is most likely to have a physical conversation and a notification will not be sent. The additional microphones can also be used for beamforming to detect if the user's head is turned towards a speech source in the user's surroundings. If this is the case the user is most likely to have a physical conversation and a notification will not be sent. The additional microphones can also be used for estimating if the headset user is answering a question from a person in their surroundings. The surrounding microphones will detect speech in the user's surroundings and if the primary microphone detects speech from the user in a flow that is estimated to be an answer or contribution to a physical conversation, then a notification will not be sent.

The introduction of a noise cancellation algorithm in combination with one or more additional microphones has been found to improve the efficiency of the VAD algorithm(s) and thus helps to distinguish between background noise and speech. Still further, with the use of an additional microphone, the discrimination of the user being in a physical conversation with a person in the surroundings is significantly improved. Thereby, unintentional mute notifications can be significantly reduced or even eliminated.

In the following preferred embodiments and features will be described, including various ways of determining the mentioned ‘additional condition’.

In preferred embodiments, the method comprises determining if it is likely that determined speech comes from a speech source in the user's surroundings, and providing the mute state notification to the user only if it is not likely that determined speech comes from a speech source in the user's surroundings. Especially, the method may comprise processing output signals from a plurality of microphones to so as to allow discrimination between speech from the user and speech from the user's surroundings. Especially, the method may comprise processing the output signals from the plurality of microphones to provide a beamforming sensitivity pattern so as to allow discrimination between speech from the user and speech from the user's surroundings.

In some embodiments, the method comprises determining if it is likely that the user has a physical conversation, and providing the mute state notification to the user only if it is not likely that the user has a physical conversation. Especially, the method may comprise performing a first VAD algorithm on output signals from a microphone capturing the user's speech, such as a mouth microphone in a headset, and performing a second Voice Activity Detection algorithm on output signals from at least one additional microphone to determine speech from another source. Especially, the method may comprise determining a timing between speech from the user and speech from another source so as to determine if it is likely that the user has a physical conversation.

The method may comprise performing a VAD algorithm on a signal indicative of sound from the at least one other participant in the call, so as to detect speech from the at least one other participant in the call. Especially, the method may comprise providing a mute state notification to the user only in case it is detected that the user speaks, while at the same time there is no speech detected from the at least one other participant in the call. Thus, in this way an intelligent mute state notification can be provided to the user, only when it is most likely that the user intends to speak in spite of the microphone being muted, namely when the user speaks while the other participants in the call are silent.

The method may comprise performing a noise cancellation algorithm by processing output signals from a primary microphone, e.g. headset mouth microphone, and output signals from an additional microphone to suppress surrounding noise. This may help increasing performance of the VAD algorithm.

If preferred, a measure of frequency of mute state notifications can be set by the user. Hereby, an even lower disturbance can be experienced, since the user can lower the frequency of notifications in case they are still found disturbing.

It is understood that a VAD algorithm detects the presence of speech in a signal. Preferably, features are extracted from the signal in time or frequency domain and used in a classification rule to determine if speech is present or not. While in a muted state, the microphone, e.g. in a headset, provides a real time signal to the VAD algorithm. Implementations of a VAD algorithm will be known by the skilled person.

In some embodiments, the method comprises the performing, by a first processor, the steps of: performing a noise cancellation on signals from the primary microphone and the additional microphone to suppress surrounding noise, processing an output signal from the microphone system according to a VAD algorithm, determining if speech is present, and determining if an additional condition is fulfilled, are performed by a first processor, such as a processor in a headset comprising the primary microphone, the additional microphone and a loudspeaker. The step of providing mute state notification, is performed by a second processor, such as a processor in a computer device or computer system facilitating said call. In such embodiments, it is preferred that the mentioned steps are utilized to determine whether to mute or transmit audio from the primary microphone to the second processor facilitating the call, namely to determine only to transmit audio from the primary microphone to the second processor facilitating the call, if it is determined that speech is present and the additional condition is fulfilled. In this way an unintended mute state notification is avoided, even though a traditional call system is used, since the normal mute state notification will not be triggered due to the muting of the primary microphone unless it is likely that the user intends to speak in the call.

In some implementations of the noise cancellation, the method comprises performing a noise cancellation algorithm on the output signals from the primary microphone and from the additional microphone involving a VAD algorithm providing an output indicative of presence of speech, and generating a noise cancelled version of the output signal from the primary microphone based on said output indicative of presence of speech. Especially, the noise cancellation algorithm may comprise applying said output indicative of presence of speech to a noise estimator which estimates noise in the output signal from the primary microphone in periods without speech present. Especially, the noise cancellation algorithm may comprise multiplying a gain vector with a frequency domain representation with a set of frequency bins of the primary microphone signal, wherein the gain vector has been generated with low gain values for frequency bins not containing speech, preferably with high gain values for frequency bins containing speech. Especially, the noise cancellation algorithm may comprise generating the gain vector in response to an input from the noise estimator, thus the gain vector is preferably generated based on the noise estimate from the noise estimator.

By using a VAD algorithm in the noise cancellation algorithm, the noise estimate is improved, since it can be based on periods only where there is not speech present. This in turn allows a good suppression of noise in the signal from the primary microphone, and with such good noise suppression, it has been found that the VAD algorithm performed for determining mute state notification is improved.

An alternative noise cancellation algorithm is based on generating a noise cancelled version of the output signal from the primary microphone by applying an adaptive noise cancellation algorithm involving an adaptive filter. Specifically, the adaptive filter may be implemented by a Least Mean Square or a Normalized Least Mean Square algorithm, such as known by the skilled person.

In a second aspect, the invention provides a device arranged for two-way audio communication, such as in a wireless format, the device comprising a microphone system comprising a primary microphone and an additional microphone, and processor system arranged to perform all steps of the method according to the first aspect, or at least the steps of the method except providing the mute state notification. Especially, said processor system may be arranged to determine to mute the primary microphone in response to said additional condition, so as to provide an audio output from the primary microphone only in case it is determined to be likely that the user intends to speak in the call. Thus, preferably the device determines to mute the primary microphone to avoid any audio being transmitted to the processor system facilitating the call, unless it is found likely that the user intends to speak in the call.

Especially, the device may be a headset, such as with the processor system forming an integral part of the headset.

The device preferably comprises a loudspeaker, so as to allow two-way audio communication. The device may e.g. be a standalone device with the microphone system and a loudspeaker in one unit with a wired (e.g. USB) or wireless connection (e.g. Bluetooth) to a computer or a smartphone or the like.

Especially, the device may comprise a headset system arranged for two-way audio communication, such as in a wireless format, the headset system comprising
a headset arranged to be worn by the user, the headset comprising a microphone system comprising a mouth microphone, an additional microphone positioned separate from the mouth microphone, and at least one ear cup with a loudspeaker,
a mute activation function which can be activated by the user to mute sound from the mouth microphone in a mute state during the call, and
a processor system arranged to perform the method according to the first aspect, or at least the steps except the step of transmitting the mute state notification, so as to determine if it is appropriate to notify the user of a mute state, when the user speaks while the mouth microphone is in the mute state, or so as to determine whether to mute the mouth microphone when the user speaks while the mouth microphone is in the mute state. Especially, it may be preferred that the processor system of the device is arranged to determine whether it is likely that the user intends to speak, and to transmit audio accordingly from the mouth microphone only in case it is determined to be likely that the user intends to speak, so as to avoid any mute state notification being sent by an entity, such as a processor system, facilitating the call.

Especially, the microphone system may comprise more than one additional microphone positioned separate from the mouth microphone. E.g. the mouth microphone may be implemented as a plurality of separate microphones so as to allow beamforming for suppressing surrounding sound captured by the mouth microphone. E.g. one or several additional microphones may be located on one or both earcups of the headset to capture surrounding sounds, e.g. for active noise cancellation of sound reaching the ears of the user. E.g. an array of additional microphones are arranged for beamforming to allow capturing speech from a limited direction relative to the user only, and/or e.g. determine a direction from which the speech comes, so as to allow determining whether it is likely that the speech is intended for the user as part of a conversation with the user, of if such speech can be considered as speech unintended for the user.

Especially, the processor system is arranged to provide the notification to the user as an audible notification via the loudspeaker, e.g. as a voice message.

Especially, the mute function may be implemented as a user operable knob or push button or contact or other means located on a part of the headset.

The processor system may be a processor as known in existing device, such as a headset. Thus, the invention is suited for easy implementation in device having a processor with extra capacity for performing the VAD algorithm etc. Thus, the necessary processing can be implemented also in a compact headset, however if preferred, the processing system may be implemented on a computer or smartphone or a dedicated device separate from the headset.

In a third aspect, the invention provides a communication system comprising
at least one device according to the first aspect, and
a communication device arranged to provide a two-way call via a communication channel and to provide two-way audio to the at least one device according to the first aspect accordingly, e.g. in a digital wireless format such as DECT, or Bluetooth or other similar short range wireless formats.

Especially, the communication device may comprise a computer or a mobile phone such as a smartphone. The communication channel may be such as a mobile network e.g. 2G, 3G, 4G, 5G or the like, the internet, or a dedicated wired or wireless communication channel. The connection between the communication device and the communication channel may be a wired or a wireless connection, e.g. the connection may involve a wi-fi connection.

Especially, the communication system may be such as a teleconference system or the like.

In a fourth aspect, the invention provides use of the method according to the first aspect for performing one or more of: a telephone call, an on-line call, and a teleconference call.

In a fifth aspect, the invention provides use of the device according to the second aspect for performing one or more of: a telephone call, an on-line call, and a teleconference call.

In a sixth aspect, the invention provides user of the system according to the third aspect for performing one or more of: a telephone call, an on-line call, and a teleconference call.

In a seventh aspect, the invention provides a program code arranged to cause the method according to the first aspect to be performed, when the program code is executed on a processor or on two separate processors. Especially, the program code may be stored in memory on a chip, or on one or more tangible storage media, or available on the internet in a version for downloading. The program code may be in a general code format or in a processor dedicated format.

It is appreciated that the same advantages and embodiments described for the first aspect apply as well the further mentioned aspects. Further, it is appreciated that the described embodiments can be intermixed in any way between all the mentioned aspects.

### BRIEF DESCRIPTION OF THE FIGURES

The invention will now be described in more detail with regard to the accompanying figures of which

FIG. 1 illustrates the situation where a headset user in an online call with call participants while being and present in a physical room with another person who speaks to the headset user during the call,

FIG. 2 illustrates steps of a method embodiment,

FIG. 3 illustrates a block diagram with elements of an embodiment,

FIG. 4 illustrates a headset system embodiment,

FIG. 5 illustrates a block diagram of elements of an embodiment with noise cancellation provided on both the primary microphone (mouth microphone) and an additional microphone prior to providing the signals from these microphones to VAD algorithms,

FIG. 6 illustrates a headset system embodiment with an additional microphones placed on the earcup and with a processor determining to transmit an audio output from the primary microphone (mouth microphone) only if it is determined that it is likely that the user intends to speak in an ongoing call,

FIG. 7 illustrates a block diagram of an example of a noise cancellation algorithm example generating a noise cancelled version of the audio signal from the primary microphone based on audio inputs from the primary microphone and an additional microphone, and

FIG. 8 illustrates a block diagram of another example of a noise cancellation algorithm based on adaptive noise cancellation.

The figures illustrate specific ways of implementing the present invention and are not to be construed as being limiting to other possible embodiments falling within the scope of the attached claim set.

### DETAILED DESCRIPTION OF THE INVENTION

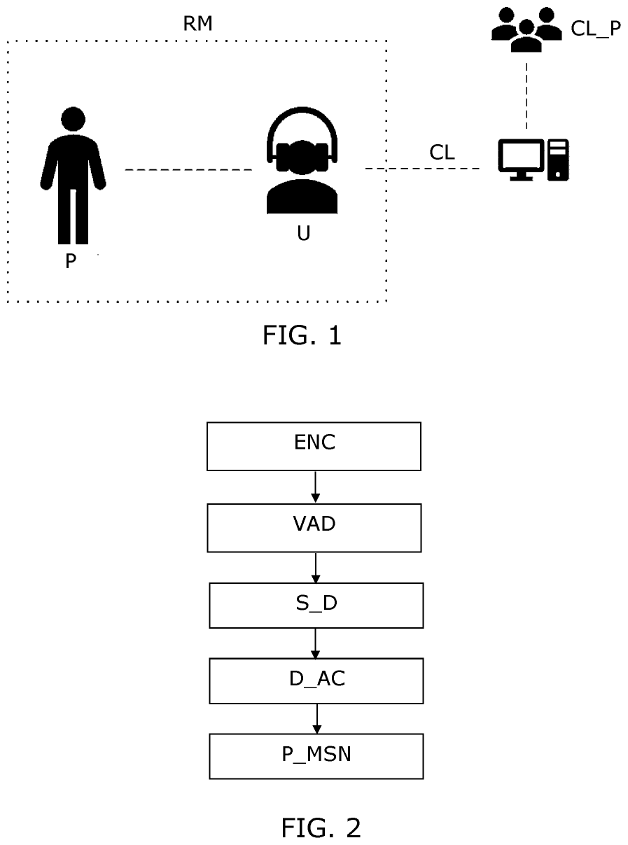

FIG. 1 shows the basic situation behind the invention, namely a user U present in a physical room RM with another person P, e.g. a colleague. The user U is in a call CL with other call participants CL_P, e.g. an online meeting via a computer or the like. The user U wears a headset for two-way communication with the call participants CL_P. If the user U has muted the headset microphone for some reason, and noise or speech is captured by the mouth microphone of the headset, a mute state notification is provided to the user U either a visible message on a display or an audible message via the loudspeaker in the headset. However, such notification is unintended and disturbing for the user U e.g. in case the sound captured is speech from the person P in the room RM and/or speech by the user U in a conversation with the person P in the room RM.

This problem is solved by the invention by using a Voice Activity Detection (VAD) algorithm and an additional condition to determine if a mute state notification should be provided to the user U. Thereby, it is possible to eliminate notification that are unintended and can disturb the user U rather than serving as an assistance.

FIG. 2 illustrates steps of a method embodiment, i.e. a method for notifying a user of a mute state of a microphone system during a call with one or more other participants, in case the user speaks while the microphone system is muted. The method comprises performing an environmental noise cancellation algorithm ENC by processing output signals from a primary microphone, e.g. headset mouth microphone, and output signals from an additional microphone to suppress surrounding noise from the environments where the user is located. Further, the method comprises processing VAD an output signal from the microphone system, at least the primary microphone, optionally both the primary microphone and the additional microphone(s) according to a VAD algorithm by means of a processor system while the microphone system is muted. Next, determining S_D if speech is present in accordance with an output of the VAD algorithm. Further, determining D_AC if an additional condition if fulfilled apart that it may have been detected that speech is present, and then finally providing P_MSN a mute state notification to the user only if it is determined that speech is present and the additional condition is fulfilled.

In some embodiments the steps ENC, VAD, S_D, D_AC are performed by a first processor in a first device such as a headset, while step P_MSN is performed by a second processor in a second device such as a computer executing a call with a distal participant. In some embodiments, all five mentioned steps are performed by a processor in one device.

The additional condition may be based on one or more separate VAD algorithms operating on additional microphones arranged to determine if speech is present in the environments around the user, and/or a separate VAD algorithm operating on incoming audio from the call to determine if other participants are speaking. This can be helpful in providing information important for determining the actual situation the user is in and thus determine if it is appropriate to provide a mute state notification or not.

By using a noise cancellation algorithm (often denoted ENC or ANC or the like), the performance of the VAD algorithm, or VAD algorithms, is/are improved.

The method as described, implemented e.g. in a headset, an intelligent way of providing mute state notifications can be applied.

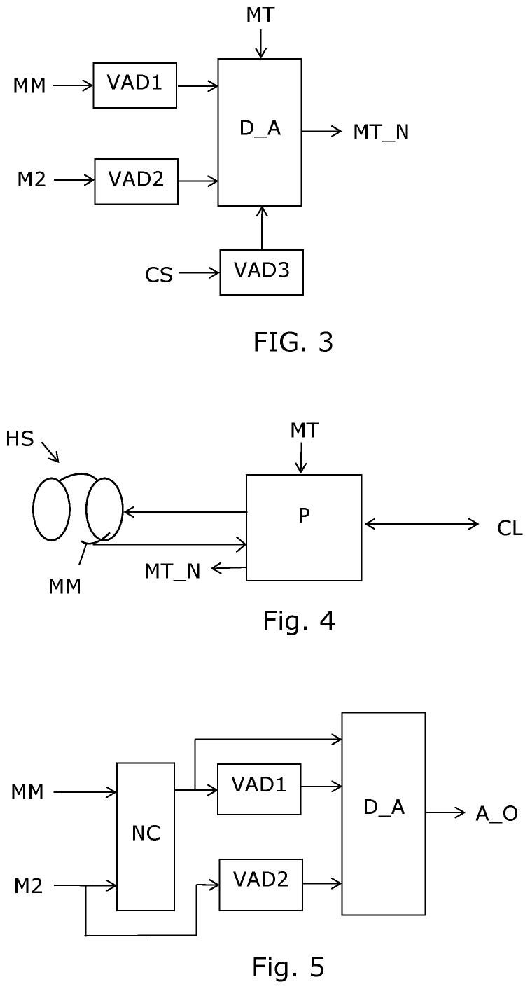

FIG. 3 shows a block diagram to illustrate a part of a headset embodiment. A determining algorithm D_A determines whether to send a mute state notification MT_N to a user when certain conditions are met, and in case the user's mouth microphone MM is in a mute state MT, i.e. blocking sound from the user during an ongoing call.

A first VAD algorithm VAD1 operates on the signal from the mouth microphone MM of the headset and determines a first input to the determining algorithm D_A, namely if speech is present. A second VAD algorithm VAD2 operates on an input from one or more microphones arranged to capture sound from the environments around the user, e.g. one or several microphones positioned on an exterior part of the headset, and it is then provided to the determining algorithm D_A if speech is present in the environments. Finally, a third VAD algorithm VAD3 operates on the sound input from the call CS, thus the third VAD algorithm serves to determine if the other participants in the call speak or are silent.

The determining algorithm D_A thus has two inputs from the VAD2, VAD3 in addition to the input from VAD1 that the user can be assumed to speak. Especially, the input from VAD2 can be used to determine if a person in the environments speaks, while the use speaks, which most likely means that the user may be in a conversation with the person present in the environments and thus not intends to speak to participants in the call, and thus a mute state notification MT_N should in such case be avoided. Further, when it is detected that the user speaks, and the call sound CS indicates that the other participants do not speak, then it is likely that the user wants to speak in the call, and thus it is appropriate to provide a mute state notification MT_N.

FIG. 4 illustrates a headset system embodiment with a headset HS to be worn by a user during a call, and it has a primary microphone in the form of a mouth microphone MM to capture the user's voice, and two earcups each with a loudspeaker to provide audio to the user from the call CL. The mouth microphone MM and loudspeakers of the headset HS are connected to a processor P, e.g. integrated into one or both earcups of the headset HS. The processor P handles two-way audio communication in connection with a call CL, such as in a wireless format. The headset HS has a mute activation function MT which can be activated by the user to mute sound from the mouth microphone MM in a mute state MT during the call CL. The mute state MT is provided as input to the processor P which determines to provide a mute state notification MT_N to the user only when it is appropriate according to a method as described in the foregoing, when it is detected by means of a VAD algorithm, that the user speaks while the mouth microphone MM is in the mute state MT.

It is to be understood that the headset system embodiment shown is arranged for wired or wireless communication of two-way audio call CL to a communication device serving to provide the call connection via a communication channel.

In some headset system embodiments, at least a part of the mute functionality for muting sound from the primary microphone or mouth microphone is implemented on a processor forming part of the headset system. Thus, in such embodiments, the headset system simply itself mutes the primary microphone when it is found likely that the user intends that the primary microphone should be muted. Thus, such embodiments are compatible with existing communication devices or computer programs serving to provide the call connection via a communication channel, since such devices or programs will only be prompted to send a mute notification in case the headset system has passed sound which is likely to be the user's speech which is intended for the call, and thus the mute notification of the devices or programs will function as intended, i.e. with an improved quality compared to using a standard headset system. However, it is to be understood that the processing and mute notification decision can, in other embodiments, be entirely performed by the device or program facilitating the call.

The following four sub aspects 1)-4) have been found to improve performance of the mute state notification method and device, and thus can be considered as preferred embodiments.

1) Context awareness by beamforming. Use of additional microphones placed on the headset to act as a microphone array. Beamforming techniques are then used to directionally locate a person, e.g. a colleague, speaking in the environments of the user. If the person is detected within a certain angle of acceptance, the method may be arranged to find the context likely to be a conversation with the person, thus it will be determined that a mute state notification should not be provided. Alternatively, or additionally, a beamforming setup can also be used to detect if the user points his/her attention towards the person. This is done by using beamforming to detect if the user turns his/her head towards the person speaking. When the person starts speaking the headset detects the person at a certain angle. When the user turns his/her head towards the person, the headset will detect the person at another angle, and thus it may be determined that a conversation is a likely context, and thus a mute state notification should not be provided.

2) Noise cancellation algorithm to optimize VAD performance. E.g. an environmental noise cancellation (ENC) algorithm may use the input of the primary microphone (e.g. mouth microphone) and one or more separate microphones to filter out surrounding noise. By combining the two techniques the VAD algorithm will not be affected as much by surrounding noise, thus the present invention will decrease the risk of an environmental sound falsely activating the mute state notification.

3) Conversation context awareness. A primary microphone (e.g. mouth microphone) capturing the user's speech and a secondary microphone (or microphones) capturing speech in the user's surroundings may be used. For each input in the two microphones, a separate running VAD algorithm detects if speech is present to let the headset know when the user is speaking and when someone is speaking in the user's surroundings. A model may be used to estimate the likelihood that the speech captured at the two microphones are part of the same conversation. This estimate can then be used to determine a mute state notification should be provided.

4) Call activity context awareness. Using two separate running VAD algorithms when the user is in a call, where one VAD algorithm detects speech in the signal from the primary microphone (e.g. mouth microphone). The other VAD algorithm detects speech by processing incoming audio from the call to determine call activity, i.e. speech activity in the call. Presence of speech in the call activity is used to estimate the likelihood that the user unintendedly is speaking into a muted microphone. If speech is not detected in the call activity and the user speaks into a muted microphone, it is estimated likely that the call participants are waiting for the user to contribute, thus a mute state notification is provided. If speech is detected in the call activity and the user speaks into a muted microphone, it is estimated less likely that the call participants are waiting for the user to contribute, thus a mute state notification is not provided in such case.

FIG. 5 shows a block diagram to illustrate a part of a headset embodiment with a mouth microphone MM as primary microphone and an additional microphone M2. A determining algorithm D_A determines whether to mute audio from the mouth microphone MM or to pass audio from the mouth microphone MM to an audio output A_O depending on whether certain conditions are met.

The audio outputs from the mouth microphone MM and the additional microphone M2 are both processed by a noise cancellation algorithm NC to cancel possible noise in the audio output from the mouth microphone MM, and a noise suppressed audio signal from the mouth microphone MM is then provided as input to a VAD algorithm VAD1. The audio output from the additional microphone M2 is processed by a separate VAD algorithm VAD2. It is to be understood that separate noise calculation algorithms may alternatively be provided to outputs from the two microphones MM, M2, if preferred.

Each of the VAD algorithms VAD1, VAD2 provide results which are provided as inputs to the determining algorithm D_A, namely an algorithm determining whether speech is present at the two microphones MM, M2, respectively. These inputs may especially be used to determine, if it is likely that the user speaks with a person in the environments, i.e. performs a physical conversation with another person. In case so, the determining algorithm D_A determines to mute audio from the mouth microphone, while providing speech from the mouth microphone at the audio output A_O in case it is detected that the user speaks, based on VAD1, while VAD2 indicates, over a period of time, that there is no additional speech in the surroundings.

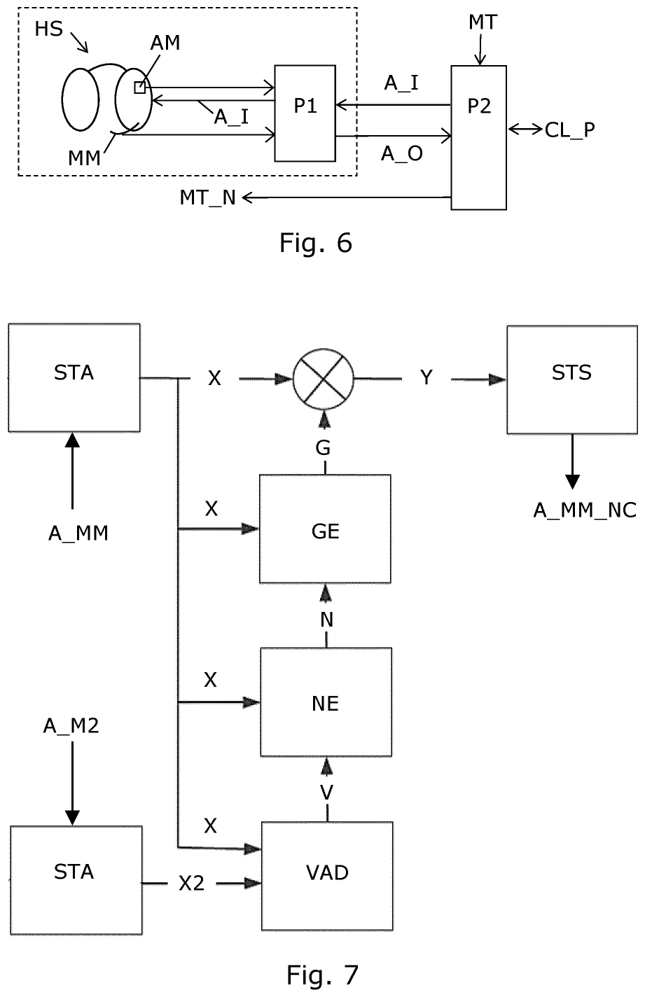

FIG. 6 shows a variant of the headset system (dashed box) of FIG. 4. In FIG. 6, the headset HS has a primary microphone, here shown as a mouth microphone MM, and an additional microphone AM to capture environmental sounds, here shown placed on an earcup of the headset HS. A processor system P1, e.g. implemented integral with one of the earcups of the headset HS, is arranged to perform a noise cancellation algorithm by processing output signals from the mouth microphone MM and the additional microphone AM so as to suppress surrounding noise. Further, the processor system P1 is arranged to process an output from the mouth microphone MM according to a VAD, optionally also performing an output from the additional microphone according to a separate VAD algorithm, e.g. as in FIG. 5. Further, the processor system P1 is arranged to determine if speech is present in accordance with an output of the VAD performed on the output from the mouth microphone MM, and further determining if an additional condition is met. The processor system P1 is arranged to generate an audio output A_O from the mouth microphone MM only in case it is determined that the mouth microphone MM captures speech and that the additional condition is met. Especially, the additional condition may be that it is determined to be likely that the user speaks, and that the user is not at the same time involved in a physical conversation with a person in the surroundings. Specifically, the determination of the additional condition may be based on processing sound captured by the additional microphone AM.

A separate processor system P2 facilitates the call and thus provides two-way audio connectivity to call participants CL_P. This processor system P2 may comprise a personal computer, a laptop, a tablet or a smartphone, or a dedicated device, serves to process the audio output A_O from the headset system and to generate an audio input A_I with audio from distal participants CL_P in the call to the headset system.

In this way, existing general purpose call or online communication programs can be used along with the headset system, and still the functionality of a more intelligent mute notification MT_N is obtained, since the separate processor system P2 provides the mute notification MT_N in the traditional way, as known from existing call systems, e.g. when the audio level in the audio output A_O exceeds a certain level when in the mute state. The notification MT_N is e.g. as a visual notification and/or an audible notification. However, since the processor system P1 in the headset system serves to provide an intelligent muting of the mouth microphone MM, it is ensured that the audio output A_O to the separate processor system P2 is provided only, when the headset system has determined that it is likely that the user intends to speak in the ongoing call, thus eliminating annoying mute state notifications MT_N even with existing call systems.

FIG. 7 illustrates an example of a noise cancellation algorithm for processing audio signals A_MM from a primary microphone and audio signals A_M2 from an additional microphone to generate a noise cancelled audio signal A_MM_NC from the primary microphone. Basically, the algorithm operates on frequency domain representations X, X2 of the respective audio input signals A_MM, A_M2. A gain vector G is multiplied with the frequency representation of the primary microphone audio signal X. The gain vector G is generated such that low gains are set on frequency bins of the frequency representation of the primary microphone signal X not containing speech. The resulting output Y of the multiplication of X and G is then transformed to a time signal A_MM_NC which represents the noise cancelled version of the original audio signal from the primary microphone A_MM.

In more details, the block diagram of FIG. 7 illustrates initial short time analyses STA performed on the respective audio signals A_MM, A_M2 and based thereon, the two audio signals A_MM, A_M2 are transform into respective frequency domain representations X, X2. In order to generate the gain vector G which gains frequency bins with speech and attenuates frequency bins without speech, X is applied to a noise estimator NE which estimates noise N, and finally a gain estimator GE generates the gain vector G based on the estimated noise N and X. The noise estimator NE receives an input V from a Voice Activity Detector VAD operating with both X and X2 as inputs, and the input V indicates to the noise estimator NE when there is speech or not, and the noise estimator NE then updates its noise estimate N in periods where there is not speech.

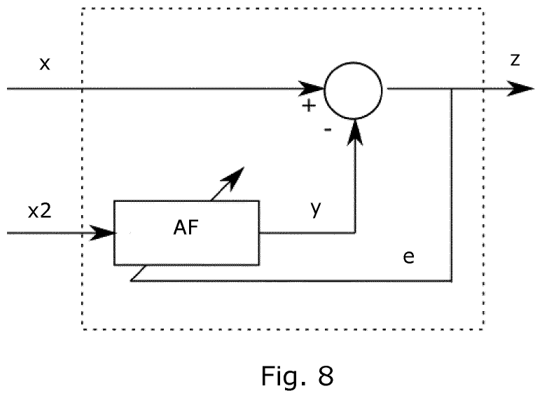

FIG. 8 illustrates a block diagram of another example of a noise cancellation algorithm based on simple adaptive noise cancellation. This algorithm is based on the assumption that the audio signal from the primary microphone x contains the intended speech as well as noise, and that the audio signal x2 from the additional microphone contains the same noise, which may not be completely valid in practice due to the two microphones being positioned at different locations.

The objective for the adaptive noise canceller is to minimize the output power z. This is achieved using the output signal as the error signal e in an adaptive filter AF. It can be proven that the smallest possible output power is achieved when y equals the noise, meaning the output signal z equals the desired signal x.

Several algorithms can be used as the adaptive filter AF, for example the normalized least mean square (NLMS) algorithm which is based on a least mean square (LMS) algorithm, where a gradient descent method is used to adjust filter coefficients to minimize the error e. NLMS normalizes the power of the input and uses a time-varying step size to converge faster.

It is appreciated that the noise cancellation examples described merely serve to illustrate that noise cancellation to suppress noise of the audio signal from the primary microphone can be implemented in various ways. Thus, the effect of improving the reliability of the VAD performed on the noise cancelled primary microphone signal can be obtained with various implementations.

In the following, additional embodiments E1-E15 will be defined.

E1. A method for notifying a user of a mute state of a microphone system during a call with one or more other participants, in case the user speaks while the microphone system is muted, the method comprising
processing (VAD) an output signal from the microphone system according to a Voice Activity Detection algorithm by means of a processor system while the microphone system is muted,
determining (S_D) if speech is present in accordance with an output of the Voice Activity Detection algorithm,
determining (D_AC) if an additional condition is fulfilled, and
providing (P_MSN) a mute state notification to the user only if it is determined that speech is present and the additional condition is fulfilled.

E2. The method according to E1, comprising determining if it is likely that determined speech comes from a speech source in the user's surroundings, and providing the mute state notification to the user only if it is not likely that determined speech comes from a speech source in the user's surroundings.

E3. The method according to E2, comprising processing output signals from a plurality of microphones to so as to allow discrimination between speech from the user and speech from the user's surroundings.

E4. The method according to E3, processing the output signals from the plurality of microphones to provide a beamforming sensitivity pattern so as to allow discrimination between speech from the user and speech from the user's surroundings.

E5. The method according to any of E1-E4, comprising determining if it is likely that the user has a physical conversation, and providing the mute state notification to the user only if it is not likely that the user has a physical conversation.

E6. The method according to E5, comprising performing a first Voice Activity Detection algorithm on output signals from a microphone capturing the user's speech, such as a mouth microphone, and performing a second Voice Activity Detection algorithm on output signals from at least one additional microphone to determine speech from another source.

E7. The method according to E5 or E6, comprising determining a timing between speech from the user and speech from another source so as to determine if it is likely that the user has a physical conversation.

E8. The method according to any of E1-E7, comprising performing a Voice Activity Detection algorithm on a signal indicative of sound from the at least one other participant in the call, so as to detect speech from the at least one other participant in the call.

E9. The method according to E8, providing a mute state notification to the user only in case it is detected that the user speaks, while at the same time there is no speech detected from the at least one other participant in the call.

E10. The method according to any of E1-E9, comprising performing a noise cancellation algorithm (ENC) by processing output signals from a primary microphone, e.g. headset mouth microphone, and output signals from an additional microphone to suppress surrounding noise.

E11. A device comprising a microphone system and processor system (P) arranged to perform the method according to any of claims E1-E10.

E12. The device according to E11, comprising a headset system arranged for two-way audio communication, such as in a wireless format, the headset system comprising
a headset (HS) arranged to be worn by the user, the headset (HS) comprising a microphone system comprising at least a mouth microphone (MM) and at least one ear cup with a loudspeaker,
a mute activation function (MT) which can be activated by the user to mute sound from the mouth microphone (MM) in a mute state during the call, and
a processor system (P) arranged to perform the method according to any of E1-E10 so as to determine if it is appropriate to notify the user of a mute state, when the user speaks while the mouth microphone (MM) is in the mute state.

E13. The device according to E12, wherein the microphone system comprises at least one additional microphone (M2) positioned separate from the mouth microphone (MM).

E14. The device according to E12 or E13, wherein the processor system (P) is arranged to provide the notification to the user as an audible notification via the loudspeaker.

E15. Use of the method according to any of E1-E10 for performing one or more of: a telephone call, an on-line call, and a tele conference call.

To sum up, the invention provides a method and device, e.g. a headset, for notifying a user of a mute state of a primary microphone during a call, in case the user speaks while the primary microphone is muted. The method comprises performing a noise cancellation algorithm (ENC) on output signals from the primary microphone and on output signals from an additional microphone capturing sound in the user's surroundings to suppress surrounding noise at the user location. Further processing output signals from the primary microphone according to a Voice Activity Detection (VAD) algorithm by means of a processor system while the primary microphone is muted. The VAD algorithm is used to determine if speech is present, and next it is determined if an additional condition if fulfilled. Then, finally providing a mute state notification to the user only if it is determined that speech is present and the additional condition is fulfilled. This is highly suitable e.g. for a headset where various noise in the mouth microphone may normally trigger an unintended and disturbing mute state notification. Via the VAD algorithm it can be ensured that only speech will trigger the notification, and via the additional condition, e.g. based on speech activity of the other participants in the call, based on speech in the surroundings of the user, an intelligent way of providing a mute state notification to eliminate or at least reduce disturbing notifications.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for notifying a user of a mute state of a primary microphone arranged to capture the user's speech during a call with one or more other participants, in case the user speaks while the primary microphone of the microphone system is muted, the method comprising:
1) performing a noise cancellation algorithm by processing output signals from the primary microphone and output signals from an additional microphone located to capture sound from the user's surroundings to suppress surrounding noise,
2) processing output signals from the primary microphone according to a Voice Activity Detection algorithm by means of a processor system while the primary microphone is muted,
3) determining if speech is present in accordance with an output of the Voice Activity Detection algorithm,
4) determining if an additional condition is fulfilled, and
5) providing a mute state notification to the user only if it is determined that speech is present and the additional condition is fulfilled.

2. The method according to claim 1, wherein determining said additional condition comprises determining a likelihood that determined speech comes from a speech source in the user's surroundings, and providing the mute state notification to the user based on the determined likelihood.

3. The method according to claim 2, comprising processing output signals from a plurality of microphones so as to allow discrimination between speech from the user and speech from the user's surroundings.

4. The method according to claim 3, further comprising processing the output signals from the plurality of microphones to provide a beamforming sensitivity pattern so as to allow discrimination between speech from the user and speech from the user's surroundings.

5. The method according to claim 1, wherein determining said additional condition comprises determining a likelihood that the user has a physical conversation, and providing the mute state notification to the user based on the determined likelihood.

6. The method according to claim 5, further comprising performing a first Voice Activity Detection algorithm on output signals from the primary microphone, and performing a second Voice Activity Detection algorithm on output signals from the additional microphone to determine speech from another source.

7. The method according to claim 5, further comprising determining a timing between speech from the user and speech from another source so as to determine a likelihood that the user has a physical conversation.

8. The method according to claim 1, further comprising performing a Voice Activity Detection algorithm on a signal indicative of sound from the at least one other participant in the call, so as to detect speech from the at least one other participant in the call.

9. The method according to claim 8, providing a mute state notification to the user based on a detection that the user speaks, while at the same time there is no speech detected from the at least one other participant in the call.

10. The method according to claim 1, wherein steps 1)-4) are performed by a first processor, while step 5) is performed by a second processor.

11. The method according to claim 1, wherein steps 1)-4) are followed by a step of determining to mute audio from the primary microphone if it is determined that speech is present and that the additional condition is fulfilled, so as to avoid transmission of a mute state notification.

12. The method according to claim 1, comprising performing a noise cancellation algorithm on the output signals from the primary microphone and from the additional microphone involving a Voice Activity Detector algorithm providing an output indicative of presence of speech, and generating a noise cancelled version of the output signal from the primary microphone based on said output indicative of presence of speech.

13. The method according to claim 12, further comprising applying said output indicative of presence of speech to a noise estimator which estimates noise in the output signal from the primary microphone in periods without speech present.

14. The method according to claim 12, further comprising multiplying a gain vector with a frequency domain representation with a set of frequency bins of the primary microphone signal, wherein the gain vector has been generated with low gain values for frequency bins not containing speech; and
generating the gain vector in response to an input from the noise estimator.

15. (canceled)

16. The method according to claim 1, comprising generating a noise cancelled version of the output signal from the primary microphone by applying an adaptive noise cancellation algorithm involving an adaptive filter.

17. (canceled)

18. A device comprising a microphone system comprising a primary microphone and an additional microphone, and a processor system arranged to perform at least steps 1)-4) of the method according to claim 1.

19. (canceled)

20. The device according to claim 18, wherein said processor system is arranged to determine to mute the primary microphone in response to said additional condition, so as to provide an audio output from the primary microphone based on a likelihood that the user intends to speak in the call.

21. The device according to claim 20, further comprising a headset system arranged for two-way audio communication, such as in a wireless format, the headset system comprising
a headset arranged to be worn by the user, the headset comprising a microphone system comprising a mouth microphone, an additional microphone positioned separate from the mouth microphone, and at least one ear cup with a loudspeaker,
a mute activation function which can be activated by the user to mute sound from the mouth microphone in a mute state during the call, and
a processor system arranged to perform at least steps 1)-4) of the method according to claim 1 so as to determine to notify the user of a mute state, when the user speaks while the mouth microphone is in the mute state, or so as to determine whether to mute the mouth microphone when the user speaks while the mouth microphone is in the mute state.

22. The device according to claim 21, wherein the processor system is arranged to determine whether it is likely that the user intends to speak, and to transmit audio accordingly from the mouth microphone based on a likelihood that the user intends to speak, so as to avoid any mute state notification being sent by an entity facilitating the call.

23. (canceled)

24. (canceled)

25. A method of implementing the device according to claim 18 for performing one or more of: a telephone call, an on-line call, and a tele conference call.
